(19) United States
(12) Patent Application Publication
(10) Pub. No.: US 2016/0232174 A1
(43) Pub. Date: Aug. 11, 2016

(54) Computer-Aided Processing of Data from a Number of Data Sources

(71) Applicants: Susanne Bullert, Munchen (DE); Thomas Peter Mahr, Munchen (DE); Regine Meunier, Wolfratshausen (DE); Ariane Sutor, Grafelfing (DE)

(72) Inventors: Susanne Bullert, Munchen (DE); Thomas Peter Mahr, Munchen (DE); Regine Meunier, Wolfratshausen (DE); Ariane Sutor, Grafelfing (DE)

(21) Appl. No.: 14/616,613

(22) Filed: Feb. 6, 2015

(51) Int. Cl. G06F 17/30; G06F 3/0484; G06T 11/20

(52) U.S. Cl. CPC G06F 17/30144; G06T 11/206; G06F 3/04842

(57) ABSTRACT

Computer-aided processing of data from a number of data sources is provided. The data is analyzed with respect to a plurality of data quality types based on respective analysis methods for each data quality type, resulting in a quality value for each data quality type. The quality values for the respective data quality types are visualized on a graphical user interface.

### BACKGROUND

The present embodiments relate to computer-aided processing of data from a number of data sources.

The processing of data is important in many fields of applications, e.g. for controlling technical processes or systems or for analyzing usage data or business data. Due to the increased amount of data, the quality of the data is to be controlled. However, data quality has different aspects. The relevance of those aspects depends on the kind of data to be analyzed. Furthermore, it is difficult for a user to keep track of the different aspects of data quality.

### SUMMARY AND DESCRIPTION

The scope of the present invention is defined solely by the appended claims and is not affected to any degree by the statements within this summary.

Although data qualities may be evaluated for specific data quality types, prior art solutions dealing with data quality do not address the data quality of several different quality types depending on properties of the data and the intended analysis. Instead, prior art approaches focus on the identification and correction of data quality problems for specific kinds of data or for data in general.

The present embodiments may obviate one or more of the drawbacks or limitations in the related art. For example, computer-aided processing of data with an improved visualization of the data quality is provided.

The method processes data from a number of data sources with the aid of a computer. To do so, the data are analyzed with respect to a plurality of data quality types based on respective data quality analysis methods for each data quality type, resulting in a data quality value for each data quality type. In other words, an analysis method specific for the respective data quality type is applied to the data. The term data quality type is to be interpreted broadly and may refer to numerical value(s) as well as to literal value(s) and a combination of numerical and literal values. After having determined the quality values for the respective data quality types, those values are visualized on a graphical user interface.

One or more of the present embodiments combine several different analysis methods in one framework and visualize the results of those analysis methods on a single graphical user interface. Although data quality analysis methods with respect to different data quality types are known, it is the first time that those analysis methods are merged in one framework.

In one embodiment, the data quality types analyzed by the method include one or more of the following types: the correctness of the data; the completeness of the data; the actuality of the data; and the consistency of the data.

The data quality types are important in many different application fields. Known data quality analysis methods may be used for those data quality types. Furthermore, appropriate analysis methods may also be derived by a skilled person on the basis of his common general knowledge. For example, a quality value for the completeness of data may be defined such that the higher the missing data elements, the lower the quality value is.

In another embodiment, the quality values for the respective data quality types are each visualized by a ring segment or ring or bar where the position of a marker along the ring segment or ring or bar indicates the quality value. This is a very intuitive visualization for the different quality values.

In another variant, one or more parameters of the step of analyzing the data, e.g. one or more analysis methods, are automatically selected based on predetermined rules. The rules may depend at least on one or more of the following quantities: the data quality types being analyzed; weighting factors of the data quality types being analyzed; and the kind of the data being analyzed.

The weighting factors may correspond to the weighting factors mentioned below. Proposals for data quality types being analyzed and/or weighting factors of the data quality types being analyzed may be visualized on the graphical user interface, where the proposals are editable by the user. An example for a predetermined rule may define which analysis method is used for a specific kind of data and a specific data quality type. A rule may also define the analysis of which data quality type with which weighting factor is proposed for specific kinds of data. By the appropriate definition of rules, the quality analysis may be adjusted depending on the specific field of application. Examples of parameters selected by the predetermined rules are specific parameters of the respective analysis methods or the weighting factors mentioned below.

In one embodiment, the graphical user interface provides a way for enabling a user to perform one or more of the following actions: selecting one or more of the predetermined rules out of a plurality of rules; editing one or more of the predetermined rules; defining one or more of the predetermined rules.

Hence, in this embodiment, a user may adjust the rules according to needs and to the field of application.

In another variant, the graphical user interface provides a way for enabling a user to adjust one or more parameters of the step of analyzing the data. For example, the parameters of the respective analysis methods may be adjusted by a user.

In an embodiment, the method includes calculating an overall quality value based on all data quality types being used for analyzing the data and visualizing the overall quality value. In one embodiment, predetermined weighting factors for respective data quality types are processed for calculating the overall quality value. For example, the overall quality value may be a weighted sum of the quality values for the respective data quality types where the weights of the summands in the sum are the weighting factors. This enables an appropriate calculation of an overall quality value taking into account all data quality types.

In order to adjust the weighting factors by a user, the graphical user interface may provide a way for enabling a user to edit the predetermined weighting factors.

In another embodiment, the overall quality value is visualized by a ring segment or ring or bar where the position of a marker along the ring segment or ring or bar indicates the overall quality value.

Furthermore, in another embodiment, at least one weighting factor (e.g., each weighting factor) is visualized by a ring segment or ring or bar where the position of a marker along the ring segment or ring or bar indicates the weighting factor. In one embodiment, the weighting factor may be adjusted by a user by moving the marker along the ring segment or ring or bar.

In another embodiment, the graphical user interface provides a way for enabling a user to select said data to be analyzed. Hence, the method of may be used for any kinds of any different data.

In another variant, the graphical user interface provides a way for displaying at least one of the following proposals: proposals for improving the data quality for at least one (e.g., each) data quality type; proposals for coping with deficiencies with respect to at least one (e.g., each) data quality type when using the data for further analysis purposes.

A user is provided with helpful information how he may improve the data quality. The definition of corresponding proposals may be defined by predetermined rules, where the rules are, for example, editable by the user. The definition of rules may be done by a skilled person based on his common general knowledge. In one embodiment, at least one proposal referring to a respective data quality type depends on at least one of: the data quality type; the kind of the data; a weighting factor for the data quality type; and the quality value for the data quality type. The weighting factor may be the above-mentioned weighting factor.

The data processed by one or more of the present embodiments may be any kind of data. For example, the data may include at least one of: sensor data; data relating to business relations; medical data; usage data; and vehicle traffic data.

Besides the above method, one or more of the present embodiments include an apparatus for computer-aided processing of data from a number of data sources. The apparatus includes a controller (e.g., a processor or a computer) for analyzing the data with respect to a plurality of data quality types based on respective analysis methods for each data quality type, resulting in a quality value for each data quality type. The apparatus also includes a graphical user interface for visualizing the quality values for the respective data quality types.

In one embodiment, the apparatus is adapted to perform one or more of the above described embodiments of the method.

Furthermore, one or more of the present embodiments relate to a non-transitory computer-readable storage medium storing a computer program with program code having instructions for carrying out a method according to one or more of the present embodiments of the method when the program code is executed on a computer.

### BRIEF DESCRIPTION OF THE DRAWINGS

FIG. 1 shows a graphical user interface generated based on an embodiment.

### DETAILED DESCRIPTION

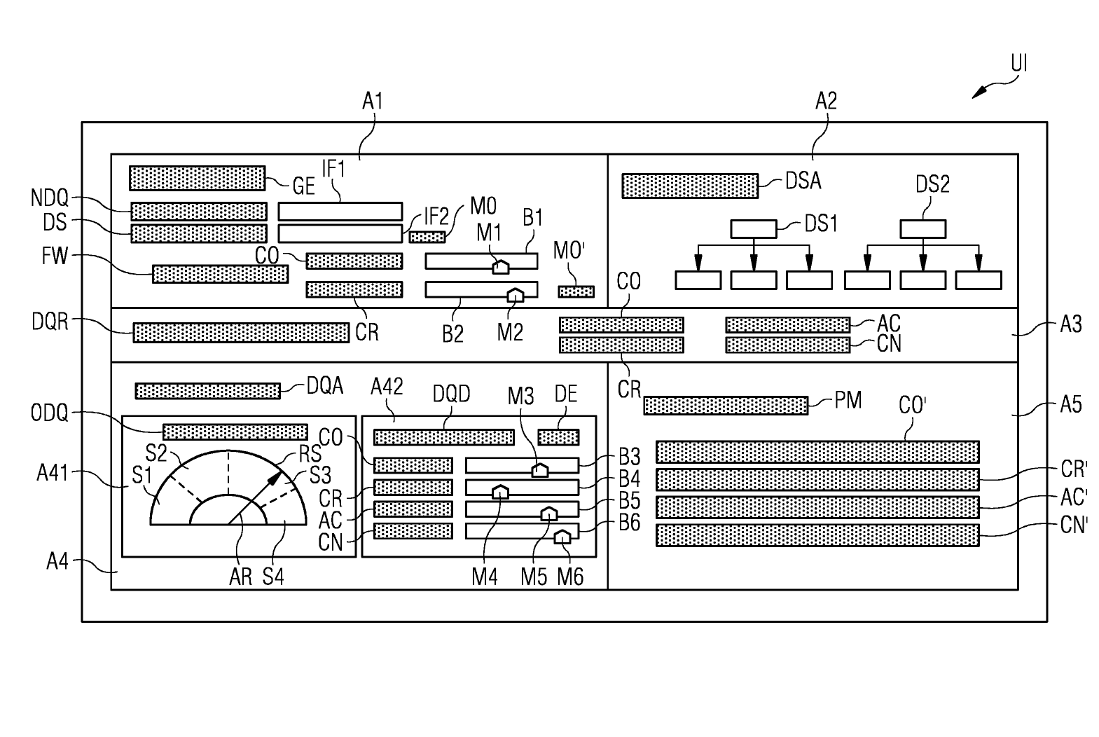

FIG. 1 is a schematic representation of an exemplary graphical user interface UI. Therein, all dotted fields are text fields representing respective text on the position of the text field in the real representation of the graphical user interface. The texts of the different text fields are mentioned below. All elements of the graphical user interface including the text fields are referenced by reference signs in FIG. 1. In the real representation of the user interface, those reference signs are not included. Furthermore, the graphical user interface includes colored sections that will be described in the following but are not shown in the schematic representation of FIG. 1.

The graphical user interface UI is displayed on a display (e.g., on a computer monitor). To interact with the graphical user interface, a cursor (not shown) on the display is used. This cursor may be moved by a user to different elements on the user interface in order to activate specific functions. In one embodiment, the cursor is moved by a computer mouse, and the activation of the specific functions is performed by clicking on a mouse button. The graphical user interface UI is generated by a computer program stored in a computer where the program also executes the algorithms for data analysis that are described in the following.

In an area A1 of the graphical user interface UI, general information of the data to be analyzed are displayed and may be selected by a user. The field GE in the area A1 has the text “General Information”. The field NDQ has the text “Name of DQ Analysis”, where DQ stands for data quality. The field IF1 adjacent to the right of the text “Name of DQ Analysis” is provided for a user in order to specify a name for the data quality analysis. The name is input by the user in the field IF1 via a corresponding keyboard. The field DS has the text “Data source(s)”. The field IF2 to the right of the field DS is provided for the user in order to specify data sources where the quality of the data in those data sources is to be analyzed. The data sources may be input by the user in the field IF2 via a keyboard or by specifying a path on a computer or a network via a separate window showing the data structure on the computer or the network. This separate window appears when clicking into the field IF2. The text field MO has the text “more”, and by clicking on this text, additional data sources may be added in the field IF2, where the additional data sources are also analyzed by the method described herein.

The text field FW has the text “Fit to need weight”, the text field CO has the text “Completeness”, and the text field CR has the text “Correctness”. The terms “Completeness” and “Correctness”, as well as the terms “Actuality” and “Consistency” mentioned below represent data quality types (also referred as to dimensions in the following) for which quality values are determined by the method. The bar B1 with the corresponding marker M1 indicates a weighting factor with respect to the dimension completeness by the position of the marker along the bar. In the embodiment described herein, the weighting factor for completeness and also for the other data quality types lies between 0% and 100%. The value 0% lies at the left end of the bar B1, and the value 100% lies at the right end of the bar B1 with a linear increase of the weighting factor between the left and right ends. The current weighting factor is indicated by the marker M1 positioned between 0% and 100%. The percentages 0% and 100% may also be included in textual form at the left and the right ends of the bar B1. Analogously to the dimension completeness, the weighting factor for the dimension correctness is visualized by the marker M2 positioned along the bar B2, where 0% is at the left end, and 100% is at the right end of the bar B2. Furthermore, the percentages 0% and 100% may also be indicated by corresponding text at the left end and the right end of the bar B2.

The text field MO′ has the text “more”. When a user clicks on this text, additional bars are shown on the graphical user interface UI. Those bars refer to the weighting factors of the dimensions accuracy and consistency. The respective bars with corresponding markers are identical to the bars B1 and B2 with the markers M1 and M2 and, thus, will not be described in detail once again. A user may move the markers of the respective bars with the mouse by pinning the cursor to the marker and slide the marker along the bar in order to adjust the weighting factors. The weighting factors are taken into account when calculating the overall quality value for the data, as will be described in more detail below. Optionally, the bars B1 and B2 as well as the additional bars for the dimensions accuracy and consistency may each have an additional marker in a different color that shows a proposal or suggestion for the respective weighting factor, where the proposal is automatically calculated by the computer program. The user may then decide if he follows the suggestions or remains with his own preferences for the analysis.

The area A2 of the graphical user interface UI enables a user to select the data to be analyzed. The text field DSA has the text “Data Selection Area”. The area A2 visualizes different data structures for selection. In FIG. 1, two data sources DS1 and DS2 in the form of data trees are shown. Groups of data in the respective trees are indicated by rectangles forming nodes of the trees. In the scenario of FIG. 1, a user has specified in the field IF2 the data sources DS1 and DS2 with the consequence that those data sources appear in the area A2. A user may select specific groups of data from the sources by moving the cursor with the mouse on the corresponding rectangle and clicking on a mouse button. A visual feedback is given by highlighting the selected rectangles. Only the selected groups of data will be analyzed.

After having selected the appropriate data sources and groups of data in the areas A1 and A2 and after having specified the weighting factors in the area A1, different data quality analysis algorithms are performed for the data quality types completeness, correctness, accuracy and consistency. Predefined rules that specify analysis algorithms for the various data types are used. Corresponding analysis algorithms are well-known for a person skilled in the art and, thus, are not described in detail herein.

Via the area A3, the user has the possibility to edit the rules. Furthermore, the user may select predefined rules and also define specific rules. The area A3 includes the text field DQR having the text “Data Quality Rules Management”. Furthermore, the area A3 has the text fields CO, CR, AC and CN. The text field CO has the text “Completeness”, the text field CR has the text “Correctness”, the text field AC has the text “Actuality”, and the text field CN has the text “Consistency”. When a user clicks on the respective texts with the mouse, corresponding rules relevant for the respective quality types completeness, correctness, actuality and consistency may be selected, changed or defined. The interactions for selecting, changing and defining rules are not described in detail herein. In general, when clicking on a respective text, another window opens on the graphical user interface enabling a user to perform the interactions via standard mouse commands. The algorithms for the various data quality types are performed based on the selected, edited and/or defined rules. An example for a rule may specify which algorithm for a data quality type is to be used for a specific kind of data. The area A3 may also be designed such that specific parameters of the analysis algorithms may be changed by the user.

The results of the analysis algorithms are represented on the graphical user interface UI in the areas A4 and A5. The area A4 includes the text field DQA having the text “Data Quality Analysis”. The area A4 has the sub-areas A41 and A42. In the area A42, the data quality types correctness, completeness, accuracy and consistency with the corresponding quality values are visualized. The area A42 includes the text field DQD having the text “Data Quality Dimensions”. Furthermore, the area A42 has the text field DE with the text “Details”. By clicking on this text, further details for the information displayed in area A42 are output on the user interface. The area A42 has the text fields CO with the text “Completeness”, the text field CR with the text “Correctness”, the text field AC with the text “Actuality”, and the text field CN with the text “Consistency”. To the right of each text field, there is a corresponding bar with a marker analogously to the bars B1, B2 and markers M1, M2 shown in area A1. The bar for the quality type completeness is designated as B3 with the corresponding marker M3. The bar for the quality type correctness is designated as B4 with the corresponding marker M4. The bar for the quality type accuracy is designated as B5 with the corresponding marker M5. The bar for the quality type consistency is designated as B6 with the corresponding marker M6.

The positions of the markers along the bars visualize the quality value of the respective quality dimension. Analogously to the above weighting factors, the quality values are described in a value range between 0% and 100%. The left side of the bars B3 to B6 refers to the value 0%, and the right side refers to the quality value 100%. The values increase linearly between the left and the right side of the bars. Additionally, the values of 0% and 100% may also be indicated by corresponding text below the bar B6 at the left and at the right end. By corresponding colors in the respective bars, different quality value ranges may be indicated within the bar. For example, a red color may be used at the left side of the bar in order to indicate low quality values where the color changes continuously towards the right side of the bar to other colors, resulting in a green color at the right end of the bar indicating high quality values. Contrary to the markers in the bars of field A1, the markers M3 to M6 may not be moved by a user because the markers indicate non-editable results of the analysis algorithms.

In another embodiment, the sub-area A42 may include various tabs at an upper edge for visualizing different kinds of information. Besides the information of the data quality dimensions shown in FIG. 1, another kind of information may be shown by clicking on the respective tab, e.g. quality values for only parts of the data sources selected by the users.

Additionally to the quality values for the respective quality types, an overall data quality value for all quality dimensions is determined in the embodiment described herein. To do so, the weighted sum of the quality values for the different dimensions is calculated, where the weights in the sum for the respective quality dimensions are specified by the user via the above described markers M1 and M2 in the area A1. The overall data quality value is visualized in sub-area A41. This area includes the text field ODQ having the text “Overall Data Quality Status”. Below this text, a ring segment RS covering a range of 180° is shown where the left end of the ring segment corresponds to 0% of the overall data quality value, and the right end of the ring segment corresponds to 100% of the overall data quality value. The overall data quality value increases linear from 0% to 100% along the ring segment RS from the left to the right. A corresponding text “0%” and “100%” may be indicated on the left end and the right end of the ring segment RS, respectively. By the arrow AR, the calculated value of the overall data quality is indicated by a position of the arrow AR along the ring.

The ring segment RS includes several sub-segments named as S1, S2, S3 and S4. The sub-segments S1, S2, S3 and S4 have different colors and are used in order to indicate value ranges of the overall data quality value. For example, for low data quality values, the sub-segment S1 may be in red color, whereas the color of the other sub-segments is different. For example, for high overall data quality values, the sub-segment S4 may have green color.

In the area A5, proposals for measures based on the data quality values of the various data quality dimensions are presented to the user in textual form. The text field PM has the text “Proposal for Measures”. The text field CO′ includes the text “Completeness” followed by a corresponding measure that may be performed for the data in order to improve the completeness or to cope with deficiencies with respect to completeness when using the data for further analysis purposes. The text field CR′ has the text “Correctness”, followed by a measure that may be performed for the data in order to improve the correctness or to cope with deficiencies with respect to correctness. The text field AC′ has the text “Actuality” followed by a measure that may be performed for the data in order to improve the actuality of the data or to cope with deficiencies with respect to actuality. The text field CN′ has the text “Consistency” followed by a measure that may be performed for the data in order to improve the consistency or to cope with the deficiencies with respect to consistency. Appropriate measures for improving the respective quality types and appropriate measures for coping with specific data quality deficiencies are well-known for a skilled person. For example, the completeness of sensor data may be improved by statistical methods, such as the imputation of missing sensor data. Additionally, for this example, the application of uncertainty methods at the point of further analyzing such data with deficiencies with respect to completeness of sensor data may be suggested. As a matter of course, such statistical methods are not appropriate as a measure for addressing deficiencies of completeness of other kinds of data, e.g. business data.

The present embodiments have several advantages. One or more of the present embodiments enable the analysis of the data quality with respect to single or composed data sources based on predetermined algorithms and rules that may be adjusted by a user via a graphical user interface. The results of the data quality analysis are visualized on different levels with different views on the analysis. An overall data quality value is shown on the graphical user interface. The data quality values for different quality types are shown on the user interface. One or more of the present embodiments also provide proposals for measures to improve problems in the data quality, e.g. to add missing data by statistical algorithms, which is important for sensor data. The different data quality types are weighted by corresponding weighting factor, where the weighting factors may be adjusted by a user depending on the application. Summarized, the present embodiments provide a visually assisted guidance for a user in order to analyze and improve the quality of data in one or more data sources.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding or following claim, whether independent or dependent, and that such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for computer-aided processing of data from a number of data sources, the method comprising:
analyzing, by a processor, the data with respect to a plurality of data quality types based on respective analysis methods for each data quality type of the plurality of data quality types, resulting in a quality value for each data quality type of data quality types; and
visualizing the quality values for the respective data quality types on a graphical user interface.

2. The method of claim 1, wherein the plurality of data quality types comprises correctness of the data, completeness of the data, actuality of the data, consistency of the data, or any combination thereof.

3. The method of claim 1, wherein the quality values for the respective data quality types are each visualized by a ring segment, ring, or bar, where a position of a marker along the ring segment, ring, or bar indicates the quality value.

4. The method of claim 1, wherein one or more parameters of the analyzing of the data are automatically selected based on predetermined rules.

5. The method of claim 4, wherein the predetermined rules depend at least on data quality types being analyzed, weighting factors of the data quality types being analyzed, a kind of the data being analyzed, or any combination thereof.

6. The method of claim 5, wherein proposals for at least one data quality type of the plurality of data quality types are analyzed, and weighting factors of the data quality types being analyzed are visualized on the graphical user interface, and
wherein the proposals are editable by a user.

7. The method of claim 4, wherein one or more of the predetermined rules are selectable out of a plurality of rules, one or more of the predetermined rules are editable, one or more of the predetermined rules are definable, or any combination thereof, via the graphical user interface.

8. The method of claim 1, wherein one or more parameters of the step of analyzing the data is adjustable via the graphical user interface.

9. The method of claim 1, further comprising:
calculating an overall quality value based on all data quality types being used for analyzing the data; and
visualizing the overall quality value.

10. The method of claim 9, wherein calculating the overall quality value comprises processing predetermined weighting factors for respective data quality types.

11. The method of claim 10, wherein the predetermined weighting factors are editable via the user interface.

12. The method of claim 9, wherein the overall quality value is visualized by a ring segment, ring, or bar, where a position of a marker along the ring segment, ring, or bar indicates the overall quality value.

13. The method of claim 10, wherein at least one weighting factor is visualized by a ring segment, ring, or bar, a position of a marker along the ring segment, ring, or bar indicating the at least one weighting factor, the weighting factor being adjustable by a user by moving the marker along the ring segment, ring, or bar.

14. The method of claim 1, wherein the data to be analyzed is selectable via the graphical user interface.

15. The method of claim 1, wherein proposals for improving a data quality for at least one data quality type of the plurality of data quality types, proposals for coping with deficiencies with respect to at least one data quality type of the plurality of data quality types when using the data for further analysis purposes, or a combination thereof is displayable via the graphical user interface, and
wherein the proposals are defined by predetermined rules.

16. The method of claim 15, wherein at least one proposal referring to a respective data quality type depends on the data quality type, the kind of the data, a weighting factor for the data quality type, the quality value for the data quality type, or any combination thereof.

17. The method of claim 1, wherein the data includes sensor data, data relating to business relations, medical data, usage data, vehicle traffic data, or any combination thereof.

18. An apparatus for computer-aided processing of data from a number of data sources, the apparatus comprising:
a processor configured to analyze the data with respect to a plurality of data quality types based on respective analysis methods for each data quality type of the plurality of data quality types, resulting in a quality value for each data quality type; and
a graphical user interface configured for visualizing the quality values for the respective data quality types.

19. A non-transitory computer-readable storage medium storing instructions executable by a computer for computer-aided processing of data from a number of data sources, the instructions comprising:
analyzing the data with respect to a plurality of data quality types based on respective analysis methods for each data quality type of the plurality of data quality types, resulting in a quality value for each data quality type of data quality types; and
visualizing the quality values for the respective data quality types on a graphical user interface.
